(19) United States
(12) Patent Application Publication
(10) Pub. No.: US 2025/0381966 A1
(43) Pub. Date: Dec. 18, 2025

(54) METHOD AND OPERATING SYSTEM FOR A VEHICLE

(71) Applicant: ZF CV Systems Global GmbH, Bern (CH)

(72) Inventor: Julian Van Thiel, Großburgwedel (DE)

(21) Appl. No.: 19/236,045

(22) Filed: Jun. 12, 2025

(30) Foreign Application Priority Data
Jun. 18, 2024 (EP) 24182870.6

(51) Int. Cl. B60W 50/02; B60R 16/023

(52) U.S. Cl. CPC B60W 50/0205; B60R 16/0232; B60W 2050/021

(57) ABSTRACT

An operating system (100) for a vehicle (300) includes a first control unit (110). The first control unit (110) has a first primary input acquisition unit (112), a first secondary input acquisition unit (118), a first communication unit (122), and a first interface (128). The first communication unit (122) is connected to the first interface (128) to receive second secondary electrical information (220) from a second control unit (210). The first communication unit (122) is also configured to receive first primary electrical information (116) from the first primary acquisition unit (112) and is further configured to transmit data (124) to the primary control device (126) depending on the first primary electrical information (116) and/or the second secondary electrical information (220).

### FIELD

The present disclosure relates to the field of vehicles and in particular the field of commercial vehicles, such as trucks, semi-trailers, or agricultural tractors.

### BACKGROUND

Modern vehicles have a large number of control devices, which are also called “electronic control units” or ECUs for short. The control devices are used to control individual functions of the vehicle. Preferably, for example, the control devices control the actuators of the vehicle and read out the sensors of the vehicle. Examples of vehicle control devices are brake control devices, or EBS for short, for controlling various types of braking functions, such as controlling friction brakes or a parking brake of the vehicle, and air suspension control devices for controlling air suspensions.

Control devices of modern vehicles are partly connected to each other via a vehicle network for data communication, in particular a data bus, in order to exchange data with each other. For example, a control device of an air suspension system can be used to determine the mass of the vehicle. For this purpose, the prevailing pressure in the air bellows is measured with a sensor and transmitted to the control device of the air suspension system. The control device can determine the mass from the prevailing pressure and provide the determined mass for a brake control device, for example. The brake control device can take this determined mass into account when controlling the actuators.

In addition, redundant control devices are provided for various applications, especially for safety-critical applications. Thus, it is known that vehicles have, for example, a primary control device, such as a primary brake control device, and a secondary control unit, such as a secondary brake control unit. Primary and secondary control devices have essentially the same functionality, so that the primary control device performs the function assigned to it until execution is no longer possible, for example due to an error. In this case, the secondary control device takes over the tasks of the primary control device. In addition to the redundant control devices, redundancy is often provided in the actuators controlled by the control devices to further increase reliability. Sensors that form input signals for the control devices are also often provided redundantly.

According to this, control elements, such as pedals or switches, of the vehicle that are operated by a driver are equipped with redundant sensors in order to be able to continue to provide sensor values from a second sensor, such as a secondary sensor, in the event of a failure of one of the sensors, such as a primary sensor, and thus increase the reliability and thus the overall safety of the vehicle.

In order to enable the high reliability described, complex cabling is therefore necessary. For example, every control element that has redundant sensors must have separate electrical connections between the sensors and the control devices in order to enable the complete chain, at least up to redundant control devices. In addition to the redundant sensors in the control element, a redundant communication unit must also be provided. A primary sensor of a control element is thus connected to a primary control device via a primary communication unit, wherein the secondary sensor is connected to a secondary control device via a secondary communication unit. Compared to non-redundant control elements and control devices, this doubles the cabling costs between each of the control elements and the control devices.

Especially in the commercial vehicle sector, a cable connection between an interior of the cab and the frame of the vehicle, on which the control units are usually arranged, is particularly critical due to sprung or even folding driver cabs relative to a vehicle frame. Relative movements between the driver cab and the vehicle frame are possible. In particular, with an increase in the number of electrical connections in the area of these relative movements and the resulting increase in the installation space required, which is sometimes limited, the risk of a cable break and thus the risk of system failure is increased.

### SUMMARY

The object of the present disclosure is therefore to address the problems of the prior art. In particular, the present disclosure provides the possibility to provide redundant communication between operating elements and control devices, in which the risk of defective cable connections between the operating elements and the control devices or cabling cost is reduced or at least not worsened despite the redundant design. In any case, the object of the present disclosure is to find an alternative to what is known from the prior art.

According to the present disclosure, therefore, an operating system according to the present disclosure is provided.

Accordingly, an operating system is provided that includes a first control unit.

The first control unit has a first primary input acquisition unit and a first secondary input acquisition unit. The first primary input acquisition unit is used to acquire first inputs into the first control unit, while the first secondary input acquisition unit is also used to acquire the first inputs into the first control unit. The first primary input acquisition unit is designed to output first primary electrical information depending on the acquired first inputs, and preferably to generate the first primary electrical information for output depending on the acquired first inputs. The first secondary input unit is configured to output first secondary electrical information depending on the acquired first inputs, and preferably to generate the first secondary electrical information for output depending on the acquired first inputs.

For example, the first inputs correspond to or result from, for example, a mechanical movement performed by a driver of the vehicle to signal a driver's request. For example, the first few inputs can be different positions of a switch or different positions of a pedal or selector lever. Thus, the first primary input acquisition unit acquires these first inputs in the same way as the first secondary input acquisition unit, and the two input acquisition units independently generate corresponding electrical information, namely the first primary electrical information and the first secondary electrical information.

In addition, the first control unit includes a first communication unit that is connected to the first primary input acquisition unit. The communication unit is configured to receive the first primary electrical information and to preferably generate and transmit data to a primary control device depending on the first primary electrical information. The first inputs are thus converted into first primary electrical information by the first primary input acquisition unit and this first primary electrical information is transmitted to a primary control device in the form of data with the first communication unit. For example, the primary control device can be used to control actuators or other systems depending on the first inputs and, for example, parameters stored in the primary control device or, for example, sensor values received by the primary control device.

In addition, the first control unit includes a first interface for connecting to a second control unit. The first interface is used to receive second secondary electrical information from a second secondary input acquisition unit of the second control unit. Accordingly, an interface is provided with which another, namely the second, control unit, can be connected to the first control unit in such a way that further electrical information, namely the second secondary electrical information, can be received from an input acquisition unit outside the first control unit, namely from the second secondary input acquisition unit of the second control unit.

The first communication unit is further connected to the first interface to receive the second secondary electrical information from the second control unit and transmit data to the primary control device depending on the second secondary electrical information. Thus, the first communication unit is configured to transmit data to the primary control device not only depending on the first primary electrical information of the first control unit but also depending on the second secondary electrical information of a second control unit.

The first control unit thus preferably represents a redundant communication connection for another control unit, which means that with the help of the interface between control units, additional redundant connections between the control units and the control devices can be dispensed with. The present disclosure is based on the knowledge that additional wiring between control units is less prone to faults than additional connections between the individual control units and the control devices.

According to a first embodiment, the first control unit includes a first power supply module to power the first primary input acquisition unit and/or the first communication unit. For example, the first power supply module can be connected to a primary energy source of the vehicle or a primary control device to draw energy from it. The first power supply module is thus used to supply energy to the primary input acquisition unit and the first communication unit. In the simplest case, the first power supply module can simply be a device to receive energy from a primary energy source, such as a vehicle battery, preferably via a connector of the first operating system, and distribute it unadapted to the first communication unit and the first primary input acquisition unit. However, the first power supply module can also be in the form of a voltage converter to receive energy with a voltage of, for example, 12 or 24 volts from a vehicle battery and transform it down so that, for example, a voltage of 5 volts is output for the first communication unit and the first primary input acquisition unit. Further, the first power supply module is connected to the first interface and is configured to output energy through the first interface, so that the first interface is configured to supply the second secondary input acquisition unit of the second control unit with energy from the first power supply module.

The first control unit thus not only represents a redundant communication channel for another control unit but is also configured to supply power to a redundant input acquisition unit of a second control unit, thus enabling a second control unit to operate secondary components independently of primary components of the second control unit.

According to another embodiment, the first secondary input acquisition unit is connected to the first interface. The first secondary input acquisition unit is configured to output the first secondary electrical information at the first interface depending on the acquired first inputs. The first secondary electrical information from the first secondary input acquisition unit is thus provided via the interface, so that it can be provided for a secondary control unit via another control unit, such as a second control unit, which is preferably identical to the first control unit.

The first secondary input acquisition unit with the first interface thus simultaneously enables a redundant data path or communication channel for the first control unit.

Preferably, the first secondary input acquisition unit is galvanically separated or separable from the first communication unit and/or the first power supply module. The first secondary input acquisition unit is also preferably galvanically separated or separable from the first primary input acquisition unit.

Thus, faults in the first primary input acquisition unit, the first communication unit, or the first power supply module cannot affect the first secondary input acquisition unit, or vice versa.

According to another embodiment, the operating system includes a second control unit. The second control unit has a second primary input acquisition unit for acquiring second inputs into the second control unit and for outputting second primary electrical information depending on the acquired second inputs. In addition, the second control unit includes a second communication unit that is connected to the second primary input acquisition unit. The communication unit is configured to receive the second primary electrical information and transmit data to a secondary control unit depending on the second primary electrical information.

The second control unit thus acquires second inputs that differ from the first inputs. The second inputs can also be generated by a driver by operating a switch, a pedal, or the like.

With the second primary input acquisition unit, the second inputs, which preferably correspond to or result from mechanical movements or mechanical positions of a movable element, are converted into electrical information or signals, namely the second primary electrical information, in order to send it to the second communication unit. With the second communication unit, data are generated from this that represent the second inputs and that are transmitted to a secondary control device.

In addition, the second control unit also includes an interface, namely a second interface, for connecting to the first control unit. Preferably, the first and second interfaces of the operating system are connected to each other. With the second interface, the second control unit is configured to receive the first secondary electrical information from the first secondary input acquisition unit of the first control unit. Also, the second communication unit is connected to the second interface to receive the first secondary electrical information. The second communication unit is also configured to transmit data to the secondary control device depending on the first secondary electrical information.

Thus, the second communication unit is configured to generate data depending on the second primary electrical information representing the second inputs and data depending on the first secondary electrical information representing the first inputs and to send the data to the secondary control unit.

Due to the first interface and the second interface as well as the two control units, a redundant data path can be created for the first control unit via the second control unit and vice versa. In the event of a failure of the first primary input acquisition unit, information can be transmitted from the first secondary input acquisition unit, namely the first secondary electrical information, via the first interface from the first control unit to the second interface of the second control unit, and from there transmitted to the secondary control device via the second communication unit. Preferably, the secondary control device is functionally equivalent to the primary control device and is configured to forward either the first secondary electrical information in the event of a fault and also the second primary electrical information received via the second control unit from the second communication unit to the primary control device. The data can also be processed directly in the secondary control device if a fault occurs in the primary control device.

According to another embodiment, the second control unit includes a second power supply module to supply power to the second primary input acquisition unit and the second communication unit. Furthermore, the second interface of the second control unit is configured to supply the first secondary input acquisition unit of the first control unit with energy from the second power supply module.

This means that if the first power supply module is galvanically separated from the first secondary input acquisition unit and other components of the first control unit, the first secondary input acquisition unit can be supplied with energy via the second control unit. A completely independent acquisition of the first inputs with the first secondary input acquisition unit and a corresponding forwarding of the information and data obtained from this is thus possible independently of the other modules or units of the first control unit and thus even in the event of failure of these other modules or units. In particular, in the event of a failure or fault of the primary control device, the function of the control units remains unaffected due to the rerouting via the control units.

According to another embodiment, the second control unit includes the second secondary input acquisition unit for acquiring the second inputs in the second control unit. The second control unit thus includes two input acquisition units, namely the second primary input acquisition unit and the second secondary input acquisition unit. Both input acquisition units are used to acquire the second inputs. With the second primary input acquisition unit, the second primary electrical information is generated depending on the acquired second inputs, and with the second secondary input acquisition unit, second secondary electrical information is generated depending on the acquired second inputs. The second secondary electrical information is output at the second interface.

Thus, the second secondary electrical information is transmitted via the second interface to the first interface of the first control unit, so that in the event of a fault of the second primary input acquisition unit or the second communication unit, the first control unit can be transferred to the primary control device via the first control unit.

According to another embodiment, the first control unit is a service brake control unit that has a pedal, wherein the first primary input acquisition unit includes a primary sensor and the first secondary input sensing unit includes a secondary sensor. The primary sensor and the secondary sensor are each configured to acquire a pedal position of the pedal as the first input. The primary sensor is configured to generate the first primary electrical information depending on the pedal position and the secondary sensor is configured to generate the first secondary electrical information depending on the pedal position.

A safe service brake control unit can thus be implemented.

According to another embodiment, the second control unit corresponds to a parking brake control unit. The parking brake control unit has a manual control element, such as a switch or lever. Thus, the second primary input acquisition unit includes a primary position acquisition unit, and the second secondary input acquisition unit includes a secondary position acquisition unit. The position acquisition units are each configured to acquire at least a first position and a second position of the manual control element. Preferably, in addition to the first and second positions, other positions can be envisaged and acquired. The first position of the manual control element corresponds to a parking brake activation request, with which the driver preferably requests that a parking brake be applied. The second position preferably corresponds to a parking brake deactivation request, i.e. the driver places the manual control element, such as the lever or switch, in this position to deactivate a parking brake. If the second position or another position is engaged while driving, such a position can also be recognized as an auxiliary brake request, with which the driver requests, for example, continuous deceleration, for example in the event of a downhill. The primary position acquisition unit is configured to generate the second primary electrical information depending on the acquired position, and the secondary position acquisition unit is configured to generate the second secondary electrical information depending on the acquired position.

In addition to the first control unit, it is advantageous to provide another of the control units, preferably the second control unit, as a parking brake control unit, as increased reliability is required when applying a parking brake. The combination of the first control unit as a service brake control unit and the second control unit as a parking brake control unit is particularly advantageous. This combination of the two control units of the operating system is advantageous, as the service brake control unit as well as the parking brake control unit communicate with the same type of control device, for example a brake control device, to request the respective brake requirements. Data from the corresponding communication units can thus be transferred to the same functional control device, thus avoiding forwarding the corresponding data to another control device.

According to another embodiment, the first communication unit is configured to receive third electrical information via the first interface or a first further interface from a state detection unit, in particular a steering angle sensor. For example, the steering angle sensor indicates a vehicle steering angle of rotation and outputs this as a third piece of electrical information. The first communication unit is also configured to transmit data to the primary control device depending on the third electrical information.

Alternatively or additionally, the second communication unit is configured to receive the third electrical information from the state detection unit via the second interface or a second additional interface. The second communication unit is also configured to transmit data to the secondary control device depending on the third electrical information. The control devices can thus be used to transmit further data, such as sensor data that indicate the status of an element in the area of the vehicle cabin, or, in the event that both control units are connected to the state detection unit, even to transmit this on redundant paths. Further connecting cables or data cables between control devices attached to the vehicle chassis and elements in the driver's cab area can thus be reduced or dispensed with.

According to another embodiment, the first control unit includes a first plausibility check unit in order to verify the first primary electrical information against the first secondary electrical information. Alternatively or additionally, the second control unit also includes a second plausibility check unit. The second plausibility check unit is configured to verify the second primary electrical information against the second secondary electrical information. The plausibility check units ensure that deviations in the electrical information generated from the corresponding inputs are detected. If necessary, it is possible to switch from processing the electrical information detected as incorrect to processing in which the respective redundant electrical information is processed.

According to one embodiment, the first and/or second plausibility check unit can be fed further signals for plausibility checking, in particular the corresponding electrical information. Such further signals are preferably electrical signals, for example from other sensors, in particular the respective assigned control units, or other signals from other control units.

For example, at least one limit switch may be provided in the first and/or second control unit next to the input acquisition units in order to acquire a defined position of a switch, pedal or selector lever and forward it as a further signal to the corresponding plausibility check unit. The other signals can then be taken into account in the plausibility check.

Alternatively or additionally, a first additional input acquisition unit can be provided in the first control unit and a second additional input unit in the second control unit. The first inputs can be acquired with the first additional input acquisition unit and the second additional input acquisition unit can be used to acquire the second inputs. Further electrical signals from the first further input acquisition unit can thus be fed to the first plausibility check unit for plausibility checking, and further electrical signals from the second further input acquisition unit can be fed to the second plausibility check unit for plausibility checking.

According to another embodiment, the operating system includes the primary control device and/or the secondary control device.

According to another embodiment, a data connection is provided between the primary control device and the secondary control device to exchange data between the primary control device and the secondary control device. The data connection is preferably configured to verify the first primary electrical information against the first secondary electrical information and/or the second primary electrical information against the second secondary electrical information. Accordingly, a plausibility check does not take place in the control units or in the control devices in addition to the control units. Galvanic separation of the individual acquisition units in the control units is possible, especially if plausibility checking is exclusively carried out by the primary and secondary control devices. The data connection is also preferably used to transmit the second primary electrical information from the secondary control device to the primary control device in the fault-free state of the operating system.

According to another embodiment, the primary control device and/or the secondary control device is a frame-mountable control device. The primary control device and/or the secondary control device are configured to be mounted on the vehicle in a position that is fixed relative to a vehicle frame.

Furthermore, the present disclosure relates to a vehicle with an operating system according to one of the aforementioned embodiments.

Furthermore, the present disclosure relates to a method for operating a vehicle with an operating system according to one of the aforementioned embodiments.

According to one embodiment, in the case of a fault-free first control unit and a fault-free primary control device, the method first involves the acquisition of first inputs with a first primary input acquisition unit. Furthermore, first primary electrical information depending on the acquired first inputs is output with the first primary input acquisition unit. In addition, depending on the first primary electrical information, data are transmitted to a primary control device with a first communication unit. In the mentioned fault-free case, the method also includes the steps carried out with a second control unit, wherein second inputs are first acquired with a second primary input acquisition unit and second primary electrical information depending on the acquired second inputs is output with the second primary input acquisition unit. Depending on the second primary electrical information, data are transmitted to a secondary control device by a second communication unit.

In the event that a fault of the first primary input acquisition unit, a fault of the first communication unit and/or a fault of the primary control unit occurs, the method includes the steps that first inputs are acquired with a first secondary input acquisition unit of the first control unit, wherein first secondary electrical information depending on the first inputs acquired is output with the first secondary input acquisition unit. The first secondary electrical information is then transmitted from the first control unit to the second control unit by way of a first interface of the first control unit and a second interface of the second control unit. Data are then transmitted to a secondary control device by the second communication unit depending on the first secondary electrical information.

### BRIEF DESCRIPTION OF THE DRAWINGS

Further embodiments arise based on the exemplary embodiments explained in more detail in the figures. In the figures:

FIG. 1 shows an operating system according to an exemplary embodiment,

FIG. 2 shows a vehicle with the operating system and

FIG. 3 shows the steps of a method for operating a vehicle with an operating system.

### DETAILED DESCRIPTION

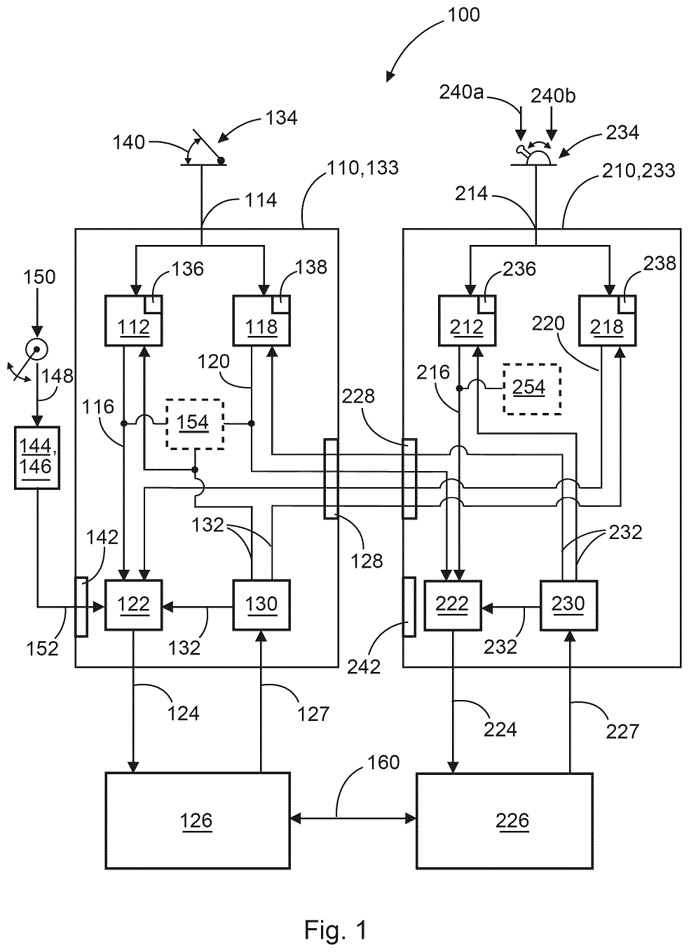

FIG. 1 shows an operating system 100 for a vehicle. The operating system 100 includes a first control unit 110 and a second control unit 210. In the exemplary embodiment shown in FIG. 1, the first control unit 110 corresponds to a service brake control unit 133, which includes a pedal 134 which can assume different pedal positions 140. Depending on the pedal positions 140, first inputs 114 are then provided for further processing. In the exemplary embodiment shown in FIG. 1, the second control unit 210 corresponds to a parking brake control unit 233. The parking brake control unit 233 includes a manual control element 134, which can be moved by a driver at least between a first position 240a and a second position 240b. According to the position 240a, 240b taken, second inputs 214 are generated for further processing in the second control unit 210.

The first control unit 110 includes a first primary input acquisition unit 112 with a primary sensor 136 and a first secondary input acquisition unit 118 with a secondary sensor 138. Electrical information is generated depending on the first inputs 114 fed to the first primary input acquisition unit 112 and the first secondary input acquisition unit 118. Thus, the first primary input acquisition unit 112 generates first primary electrical information 116 depending on the acquired first inputs 114. The first secondary input acquisition unit 118 generates first secondary electrical information 120 depending on the acquired first inputs 114.

The first primary electrical information 116 is fed to a first communication unit 122 and data 124 generated by the first communication unit 122 depending on the first primary electrical information 116 are transmitted to a primary control device 126. The primary control device 126 also provides energy 127 for a first power supply module 130, which supplies energy 132 to the first communication unit 122 as well as the first primary input acquisition unit 112. The primary control device 126 is then used, for example, to control actuators that are not shown, such as brake actuators.

In a substantially similar setup, the second control unit 210 includes a second primary input acquisition unit 212 with a primary position acquisition unit 236, which also corresponds to a sensor, for example, and a second secondary input acquisition unit 218 with a secondary position acquisition unit 238. The second inputs 214 are fed to the second primary input acquisition unit 212 and the second secondary input acquisition unit 218. With the second primary input acquisition unit 212, second primary electrical information 216 is then generated depending on the acquired second inputs 214 and output. With the second secondary input acquisition unit 218, second secondary electrical information 220 is generated accordingly depending on the acquired second inputs 214 and output. Furthermore, a second communication unit 222 is provided in the second control unit 210, which receives the second primary electrical information 216 and generates data 224 from it in order to forward this to a secondary control device 226. The secondary control device 226 provides energy 227 for a second power supply module 230, which supplies energy 232 to the second primary input acquisition unit 212 as well as the second communication unit 222.

Furthermore, the first control unit 110 includes a first interface 128 and correspondingly the second control unit 210 includes a second interface 228, wherein the first interface 128 is connected to the second interface 228. Via the interfaces 128, 228, the first secondary input acquisition unit 118 is supplied with energy 232 from the second power supply module 230 and the first secondary electrical information 120 is transmitted to the second communication unit 222 via the interfaces 128, 228. From the second communication unit 222, data 224 are transmitted to the secondary control device 226 depending on the first secondary electrical information 120. The first secondary input acquisition unit 118 is thus galvanically separated from the other components of the first control unit 110. Purely optionally, a first plausibility check unit 154 can be provided, which verifies the first primary electrical information 116 against the first secondary electrical information 120. This first plausibility check unit 154 is shown with dashes, as it can optionally be provided at this point, but is preferably arranged in the primary control device 126 or in the secondary control device 226 and is thus only an optional feature of this exemplary embodiment. Preferably, the first plausibility check unit 154 is not provided in the first control element 110 in order to achieve the complete galvanic separation mentioned above.

Likewise, the second secondary electrical information 220 is transmitted via the interfaces 128, 228 to the first communication unit 122 in order to generate data 124 from this for the primary control device 126. The second secondary input acquisition unit 218 is also supplied with energy 132 by the first power supply module 130 via the interfaces 128, 228 and is thus galvanically separated from the other components of the second control unit 210. Here too, a second plausibility check unit 254 is represented by dashes in accordance with a special embodiment in order to verify the second primary electrical information 216 against the second secondary electrical information 220. Preferably, however, this module is not provided if complete galvanic separation of the second secondary input acquisition unit 218 from the other components or elements of the second control unit 210 is desired. A plausibility check can preferably be carried out via a data connection 160 between the primary control device 126 and the secondary control device 226. Furthermore, the first control element 110 includes a first further interface 142, which is also provided in the form of a second interface 242 in the second control element 210. The first further interface 142 is connected to a state detection unit 144, which corresponds for example to a steering angle sensor 146 for acquiring a rotation angle 148 of a steering system 150, in order to receive third electrical information 152. The state detection unit 144 could also be connected to the second communication unit 222 via the second further interface 242 in order to receive the third electrical information 152 and transmit corresponding data 224 to the secondary control device 226.

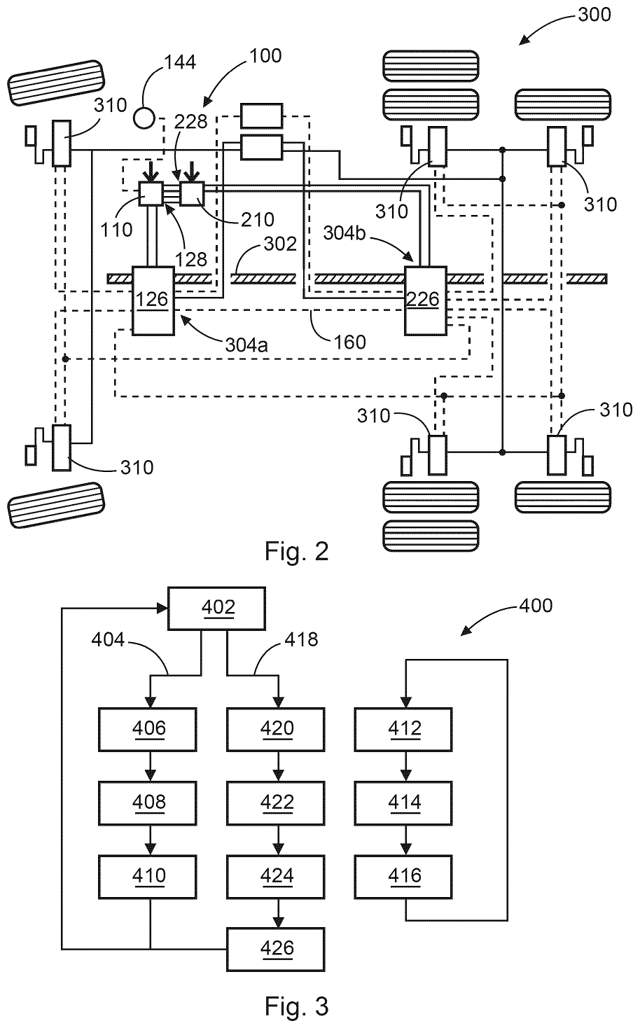

FIG. 2 shows a vehicle 300 with the operating system 100, which includes the first control unit 110 and the second control unit 210. A state detection unit 144 is connected to the first control unit 110. The first control unit 110 is connected via the first interface 128 to the second interface 228 of the second control unit 210. The first control unit is also connected to the primary control device 126 and the second control unit 210 is connected to the secondary control device 226. A data connection 160 is provided between the primary control device 126 and the secondary control device 226 for data exchange. The primary control device 126 is connected to all actuators 310, which correspond to brake actuators, for example, to control these actuators 310. The secondary control device 226 is also connected to all actuators 310 to control these actuators 310 in the event that the primary control device 126 fails, for example. Furthermore, a vehicle frame 302, which runs in the longitudinal direction of the vehicle, is shown purely as an example in the form of a beam. At a first position 304a, the primary control device 126 and at a second position 304b, the secondary control device 226 are fixedly connected to the vehicle frame 302. In contrast, the control elements 110 and 210 are arranged in a driver's cab, which is not shown here, which is sprung or foldable in relation to the vehicle frame 302. A relative movement between the control elements 110, 210 and the control devices 126, 226 can therefore occur.

FIG. 3 shows the steps of the method 400 according to an exemplary embodiment. In a step 402, it is first checked whether the first control unit 110 and the primary control device 126 are fault-free 404. In this case, in step 406 first inputs 114 are acquired with the first primary input acquisition unit 112, and in step 408 first primary electrical information 116 is output depending on the acquired first inputs 114. In step 410, the first primary electrical information 116 is transmitted to a primary control device 126 in the form of data 124. In addition, in step 412 second inputs 214 are acquired with a second primary input acquisition unit 212, and in step 414 second primary electrical information 216 is output depending on the acquired second inputs 214 with the second primary input acquisition unit 212. In step 416, data 224 are output by a second communication unit 222 depending on the second primary electrical information 216. If in step 402 a fault 418 of the first primary input acquisition unit 112, the first communication unit 122, or the primary control device 126 is detected, steps 420, 422, 424 are performed instead of steps 406, 408, 410. Steps 412, 414, 416 are carried out as previously described in the mentioned fault case. In step 420, the first inputs 114 are acquired with a first secondary input acquisition unit 118, and first secondary electrical information 120 is output from the first secondary input acquisition unit 116 in step 422. By way of a first interface 128 and a second interface 228, the first secondary electrical information 120 is transferred from the first control unit 110 to the second control unit 210 in step 424. In step 426, data 224 are transmitted to a secondary control device 226 by a second communication unit 222 of the second control unit depending on the first secondary electrical information 120.

### REFERENCE SIGNS (PART OF THE DESCRIPTION)

100 Operating System
110 First control unit
112 First primary input acquisition unit
114 First inputs
116 First primary electrical information
118 First secondary input acquisition unit
120 First secondary electrical information
122 First communication unit
124 Data
126 Primary control device
127 Energy
128 First interface
130 First power supply module
132 Energy
133 Service brake control unit
134 Pedal
136 Primary sensor
138 Secondary sensor
140 Pedal positions
142 First further interface
144 State detection unit
146 Steering angle sensor
148 Rotation angle
150 Steering system
152 Third electrical information
154 First plausibility check unit
160 Data connection
210 Second control unit
212 Second primary input acquisition unit
214 Second inputs
216 Second primary electrical information
218 Second secondary input acquisition unit
220 Second secondary electrical information
222 Second communication unit
224 Data
226 Secondary control device
227 Energy
228 Second interface
230 Second power supply module
232 Energy
233 Parking brake control unit
236 Primary position acquisition unit
238 Secondary position acquisition unit
240a First position
240b Second position
242 Second further interface
254 Second plausibility check unit
300 Vehicle
302 Vehicle frame
304a First position
304b Second position
310 Actuators
400 Method
402 Checking whether first control unit and primary control device are fault-free
404 Fault-free
406 Acquiring first inputs
408 Outputting first primary electrical information
410 Transmitting first primary electrical information
412 Acquiring second inputs
414 Outputting second primary electrical information
416 Outputting data
418 Faults
420 Acquiring first inputs
422 Outputting first secondary electrical information
424 Transmitting first secondary electrical information
426 Transferring data

What is claimed is:

1. An operating system (100) for a vehicle (300), wherein the operating system (100) includes a first control unit (110), and the first control unit (110) comprises:
a first primary input acquisition unit (112) for acquiring first inputs (114) into the first control unit (110) and for outputting first primary electrical information (116) depending on the acquired first inputs (114),
a first secondary input acquisition unit (118) for acquiring the first inputs (114) into the first control unit (110) and for outputting first secondary electrical information (120) depending on the acquired first inputs (114),
a first communication unit (122) connected to the first primary input acquisition unit (112) to receive the first primary electrical information (116), wherein the first communication unit (122) is further configured to transmit data (124) to a primary control device (126) depending on the first primary electrical information (116), and
a first interface (128) for connecting to a second control unit (210) to receive second secondary electrical information (220) from a second secondary input acquisition unit (218) of the second control unit (210),
wherein the first communication unit (122) is connected to the first interface (128) to receive the second secondary electrical information (220) and
wherein the first communication unit (122) is further configured to transmit data (124) to the primary control device (126) depending on the second secondary electrical information (220).

2. The operating system according to claim 1,
wherein the first control unit (110) includes a first power supply module (130) to supply power (132) to the first primary input acquisition unit and the first communication unit (122),
wherein the first interface (128) is configured to supply the second secondary input acquisition unit (218) of the second control unit (210) with energy (132) from the first power supply module (130).

3. The operating system (100) according to claim 1,
wherein the first secondary input acquisition unit (118) is connected to the first interface (128) to output the first secondary electrical information (120) at the first interface (128) depending on the acquired first inputs (114).

4. The operating system (100) according to claim 1, wherein the operating system (100) includes the second control unit (210), and the second control unit (210) comprises:
a second primary input acquisition unit (212) for acquiring second inputs (214) into the second control unit (210) and for outputting second primary electrical information (216) depending on the acquired second inputs (214),
a second communication unit (222) connected to the second primary input acquisition unit (212) to receive the second primary electrical information (216), wherein the second communication unit (222) is further configured to transmit data (224) to a secondary control device (226) depending on the second primary electrical information (216), and
a second interface (228) for connecting to the first control unit (110) to receive the first secondary electrical information (120) from the first secondary input acquisition unit (118) of the first control unit (110),
wherein the second communication unit (222) is connected to the second interface (228) to receive the first secondary electrical information (120), and
wherein the second communication unit (222) is further configured to transmit data (224) to the secondary control device (226) depending on the first secondary electrical information (120).

5. The operating system (100) according to claim 4,
wherein the second control unit (210) includes a second power supply module (230) for supplying power (232) to the second primary input acquisition unit (212) and the second communication unit (222),
wherein the second interface (228) is configured to supply the first secondary input acquisition unit (118) of the first control unit (110) with energy (232) from the second power supply module (230).

6. The operating system (100) according to claim 5,
wherein the second control unit (210) includes the second secondary input acquisition unit (218) for acquiring the second inputs (214) into the second control unit (210) and for outputting second secondary electrical information (220) at the second interface (228) depending on the acquired second inputs (214).

7. The operating system (100) according to claim 1,
wherein the first control unit (110) is a service brake control unit (133) with a pedal (134),
wherein the first primary input acquisition unit (112) includes a primary sensor (136) and the first secondary input acquisition unit (118) includes a secondary sensor (138) to each acquire a pedal position (140) of the pedal (134) as the first inputs (114)
wherein the primary sensor (136) is configured to generate the first primary electrical information (116), depending on the pedal position (140), and
wherein the secondary sensor (138) is configured to generate the first secondary electrical information (120) depending on the pedal position (140).

8. The operating system (100) according to claim 4,
wherein the second control unit (210) is a parking brake control unit (233) with a manual control element (234),
wherein the second primary input acquisition unit (212) includes a primary position acquisition unit (236) and the second secondary input sensing unit (218) includes a secondary position acquisition unit (238) to each acquire at least a first position (240a) of the manual control element (234) and a second position (240b) of the manual control element (234),
wherein the primary position acquisition unit (236) is configured to generate the second primary electrical information (216) depending on the acquired position (240a, 240b), and the secondary position acquisition unit (238) is configured to generate the second secondary electrical information (220) depending on the acquired position (240a, 240b).

9. The operating system (100) according to claim 4,
wherein the first communication unit (122) is configured to receive third electrical information (152) via the first interface (128) or a first further interface (142) of a state detection unit (144), and to transmit data (124) to the primary control device (126) depending on the third electrical information (152) and
wherein the second communication unit (222) is configured to receive the third electrical information (152) via the second interface (228) or a second further interface (242) from the state detection unit (144) and to transmit data (224) to the secondary control device (226) depending on the third electrical information (152) with the second communication unit (222).

10. The operating system (100) according to claim 4,
wherein the first control unit (110) includes a first plausibility check unit (154) for verifying the first primary electrical information (116) against the first secondary electrical information (120), and
wherein the second control unit (210) includes a second plausibility check unit (254) for verifying the second primary electrical information (216) against the second secondary electrical information (220).

11. The operating system (100) according to claim 4, wherein the operating system (100) includes the primary control device (126) and the secondary control device (226).

12. The operating system (100) according to claim 11, wherein the primary control device (126) and the secondary control device (226) have a data connection (160) therebetween and are configured to verify the first primary electrical information (116) against the first secondary electrical information (120) and the second primary electrical information (216) against the second secondary electrical information (220).

13. The operating system (100) according to claim 11, wherein the primary control device (126) and the secondary control device (226) is a frame-mountable control device (126, 226) which is configured to be mounted on the vehicle (300) in a position (304a, 304b) which is fixed with respect to a vehicle frame (302).

14. A vehicle (300) having an operating system (100) according to claim 1.

15. A method (400) for operating a vehicle (300) with an operating system (100) according to claim 4, wherein the method (400) comprises:
(i) performing steps with the first control unit (110) in the case of a fault-free (404) first control unit (110) and a fault-free primary control device (126), the steps including:
acquiring (406) first inputs (114) with the first primary input acquisition unit (112),
outputting (408) the first primary electrical information (116) depending on the acquired first inputs (114) with the first primary input acquisition unit (112),
transmitting (410) the data (124) depending on the first primary electrical information (116) to a primary control device (126) with the first communication unit (122),
(ii) performing steps with the second control unit (210), the steps comprising:
acquiring (412) the second inputs (214) with the second primary input acquisition unit (212),
outputting (414) the second primary electrical information (216) depending on the second inputs (214) acquired with the second primary input acquisition unit (212),
transmitting (416) the data (224) depending on the second primary electrical information (216) to a secondary control device (226) by the second communication unit (222),
(iii) wherein the method includes the following steps in the event of a fault (418) of the first primary input acquisition unit (112), a fault (418) of the first communication unit (122) and/or a fault (418) of the primary control device (126):
acquiring (420) the first inputs (114) with the first secondary input acquisition unit (118) of the first control unit (110),
outputting (422) the first secondary electrical information (120) depending on the acquired first inputs (114) with the first secondary input acquisition unit (118),
transmitting (424) the first secondary electrical information (120) from the first control unit (110) to the second control unit (210) by way of the first interface (128) of the first control unit (110) and the second interface (228) of the second control unit (210), and
transmitting (426) the data (224) depending on the first secondary electrical information (216) to a secondary control device (226) by the second communication unit (222).

16. The operating system (100) according to claim 3, wherein the first secondary input acquisition unit (118) is galvanically separated or separable from the first communication unit (122) and/or the first power supply module (130).

17. The operating system (100) according to claim 6,
wherein the second secondary input acquisition unit (218) is galvanically separated or separable from the second communication unit (222) and/or the second power supply module (230).

18. The operating system (100) according to claim 9, wherein the state detection unit (144) is a steering angle sensor (146), which indicates an angle of rotation (148) of a steering system (150) of the vehicle (300).

19. The operating system (100) according to claim 1,
wherein the first communication unit (122) is configured to receive third electrical information (152) via the first interface (128) or a first further interface (142) of a state detection unit (144), and to transmit data (124) to the primary control device (126) depending on the third electrical information (152).

20. The operating system (100) according to claim 1, wherein the operating system (100) includes the primary control device (126).
